(19) United States
(12) Patent Application Publication
(10) Pub. No.: US 2006/0100329 A1
(43) Pub. Date: May 11, 2006

(54) Paper coating formulations for rotogravure applications

(76) Inventors: Stefano Fumagalli, Carnago (IT); Tullio Pellizzon, Paderno Dugnano (IT); Giuseppe Li Bassi, Garivate (IT)

Correspondence Address: PAUL S MADAN;MADAN, MOSSMAN & SRIRAM, PC, 2603 AUGUSTA, SUITE 700, HOUSTON, TX, 77057-1130, US

(21) Appl. No.: 10/519,441

(22) PCT Filed: Jun. 27, 2003
(86) PCT No.: PCT/EP03/06823

§ 371 Date: Nov. 4, 2005

(30) Foreign Application Priority Data
Jul. 3, 2002 (IT) VA2002 A 000041

(51) Int. Cl. B05D 3/02; B05D 3/12; C08K 5/09

(52) U.S. Cl. 524/284; 427/359; 427/391; 427/395

(57) ABSTRACT

Disclosed are paper coating formulations for rotogravure printing processes containing: a. 100 parts by weight or finely divided pigments; b. from 0.001 to 5 parts by weight of one or more substances selected from the group consisting of: mono-alkylsulfosuccinate; dialkylsulfosuccinates; sulfosuccinic acid mono-esters of ethoxylated and/or propoxylated fatty alcohols; sulfosuccinic acid di-esters of ethoxylated and/or propoxylated fatty alcohols; c. from 3 to 15 parts by weight of a polymeric acrylic binder, d. from 0.005 to 0.4 parts by weight of a dispersant.

The present invention relates to paper coating formulations for rotogravure applications, and to their aqueous dispersions.

It is well known that the surface of printing paper sheets is commonly coated to improve the printability.

In the present text, with the expression “paper coating formulation” we mean the stratum of mixed pigments that is applied on the paper sheet to make them smooth and glossy and with the term “coating” the procedure used to apply it on the paper sheet.

The paper which is normally used for the manufacture of magazines or other objects (paper bags, wrappers and the like) and undergoes a rotogravure process (hereafter rotogravure paper) must possess, together with a good printability, proper characteristics in terms of:
mechanical resistance, to resist to the high speeds of the printing machines;
tint, that normally, for aesthetic reasons, it is requested to be as white as possible;
ink permeability, to avoid blurs;
smoothness and glossiness.

The obtainment of a rotogravure paper possessing all these characteristics at an optimum level is still a not completely resolved problem, and therefore, the whole of the properties of the paper used for rotogravure processes is a compromise solution.

To cite an example, the use of talc in paper coating formulations improves the printabilty of rotogravure paper and gives to the surface of the paper itself a velvet-like touch, but markedly worsens the rheological characteristics of the aqueous dispersions of the paper coating formulation, not allowing to work with a high content of solids; moreover, talc, because of its greyish tint, diminishes the brilliance and the whiteness of the paper and because of its intrinsic hydrophobic character requires great care in dispersion.

The use of special kaolins to improve the printability of paper for rotogravure process has the disadvantage that they usually exhibit poor Theological characteristics, therefore precluding the possibility to work with a high content of solids and/or at high speeds during their application.

As a conclusion, we can say that a good paper coating formulation is the result of a compromise: every improvement of the printability, even when limited, causes automatically at least one (but often all) the following drawbacks: higher costs, rheological worsening, diminishment of the whiteness, worsening of the printing machine operating level.

Any improvement of the whole of these characteristics is still the object of many research projects.

In the state of the art many methods have been described which are substantially directed to the improvement of the printabilty of paper (we cite, by way of example, US 20010051687, U.S. Pat. No. 5,085,707, U.S. Pat. No. 4,908,240), but none of the proposed methods satisfactorily solves the above mentioned problems in the case of the paper for rotogravure printing.

It is an object of the present invention a procedure to improve the printabilty of paper, and in particular the printability of the paper destined for high speeds printing processes, such as the paper for rotogravure processes.

It has now surprisingly been found that paper possess improved printability when treated with the paper coating formulation of the invention, if we compare its printability with the one of the paper coated with the common aqueous suspensions comprising pigments, adhesive, and dispersing agents.

According to a fundamental aspect of the present invention, the paper coating formulations for rotogravure processes contain:
a. 100 parts by weight of finely divided pigments;
b. from 0.001 to 5 parts, preferably from 0.01 to 1, more preferably from 0.02 to 0.8 by weight, of one or more substances selected from the group consisting of: mono-alkylsulfosuccinate; di-alkylsulfosuccinates; sulfosuccinic acid mono-esters of ethoxylated and/or propoxylated fatty alcohols; sulfosuccinic acid di-esters of ethoxylated and/or propoxylated fatty alcohols;
c. from 3 to 15 parts by weight of a polymeric acrylic binder;
d. from 0.005 to 0.4 parts by weight of a dispersant. According to a preferred aspect of the invention the mono- and di-alkylsulfosuccinate utilisable are mono- or di-C₂-C₁₆ linear or branched alkylsulfosuccinates; more preferably the di-alkylsulfosuccinate is dioctylsulfosuccinate.

The sulfosuccinic acid mono- and di-esters of ethoxylated and/or propoxylated fatty alcohols useful for the realization of the present invention are ethoxylated and/or propoxylated with from 1 to 50, preferably from 20 to 40 moles of oxide.

With the term fatty alcohol in the present text we mean C₈-C₃₀ linear or branched alkyl alcohols.

The finely divided pigments, preferably having from 40 to 90% of the particles finer than 2 μm, are the one normally employed in the coating of paper for rotogravure printing, and particularly kaolins, calcium carbonate, talc, titanium dioxide, barium sulfate, gypsum.

The mixture of finely divided pigments preferably contains at least 30% by weight of kaolin for rotogravue printing having from 40 to 70% of the particles finer than 2 μm.

Among the polymeric acrylic binder preferred for the realisation of the invention we cite the polymers of acrylic or methacrylic acid esters, the copolymers of acrylic monomers and vinyl acetate, styrene, butadiene or mixture thereof; among the preferred dispersants we cite the aqueous solutions of sodium or ammonium polyacrylates.

In addition to the above cited substances, the paper coating formulation for rotogravure printing of the invention preferably contain from 0.3 to 2 parts by weight of calcium stearate.

The paper coating formulation is normally applied to the sheet in the form of aqueous dispersion further containing thickeners and, possibly, anti-foaming agents; for the realisation of the present invention, preferably, the aqueous dispersion contains from 40 to 70% by weight of the paper coating formulation for rotogravure printing above described and from 30 to 60% by weight of water.

A further advantage of the invention is that the aqueous dispersions of the paper coating formulation do not necessarily need the presence of anti-foaming agents; or, at least, the need of said agents in order to avoid the formation of foams which reduce the operating speed of the coating machines and adversely affect the printability of paper, is substantially diminished.

It is a further object of the present invention the paper for rotogravure printing processes that is coated with from 4 to 15 g/m2, preferably from 6 to 10 g/m², of a thin layer of the paper coating formulation above described.

### EXAMPLE 1

Five aqueous dispersions of paper coating formulations are prepared with the following ingredients:
delaminated pre-dispersed kaolin, particle size 75% finer than 2 μm (Kaolin A);
delaminated kaolin for rotogravure printing, particle size 50% finer than 2 μm (Kaolin B);
78% by weight dispersion of calcium carbonate GCC, particle size about 90% finer than 2 μm (Carbonate A);
Reotan A, dispersant based on sodium polyacrylate commercialised by Lamberti SpA (Italy);
Acronal 500 D, an acrylic polymeric binder for rotogravure printing commercialised by BASF;
Lamkote, calcium stearate in emulsion commercialised by Lamberti SpA (Italy);
Carbocel MM3, carboxymethylcellulose commercialised by Lamberti SpA (Italy) having Brookfield viscosity of 20-50 mPa*s at 60 rpm in a 2% by weight aqueous solution;
Viscolam 30, a polyacrylic thickener, commercialised by Lamberti SpA (Italy).

Preparation of the “Base” Aqueous Dispersion.

(The “base” aqueous dispersion will then be used to obtain the five aqueous dispersion of the paper coating formulations to be tested, to avoid experimental errors and to guarantee the comparability of the results)

A 68% by weight dispersion is prepared adding to 296.5 g of water, under vigorous stirring, 630 g of Kaolin A, 0.13 g of Reotan A and 25% aq. NaOH to obtain a pH of 8.5-9. The dispersion is obtained stirring with a caowles at 1000 rpm for 30 minutes.

Then, in the same manner a second dispersion (having a content of solids of 68% by weight) is prepared with: 487.6 g of water, 990.0 g of Kaolin B, 4.0 g of Reotan A and 25% aq. NaOH.

With the thus obtained two dispersions of kaolins the “base” aqueous dispersion is prepared as follows.

The two dispersions of kaolins are mixed with a caowles at 1000 rpm; then 230.8 g of Carbonate A are added and the mixture is homogenised by stirring at 1000 rpm for 30 minutes.

Then the stirring speed is diminished to 700 rpm and 288 g of Acronal 500 D are added; after 10 minutes stirring 27 g of Lamkote are added; after 5 minutes stirring 9 g of Carbocel MM3 (previously prepared as a 5% wlw aqueous solution); finally, 18 g of Viscolam 30 are added, always under stirring. The pH of the dispersion is then 8.6.

The dry fraction is then determined with a Mettler-Toledo thermo-balance set at 105° C. (result emitted after 3 minutes of constant weight) and water is added to dispersion until the desired value of dry fraction (60.8%) is obtained.

Finally the “base” aqueous dispersion is homogenised by stirring at 700 rpm for 15 minutes.

Five portions (each weighing 400 g) of the “base” aqueous dispersion are taken to prepare the aqueous dispersions of the paper coating formulations used for the following comparative tests.

The first portion is used as such as the aqueous dispersion of the reference paper coating formulation (Dispersion 1).

The Dispersion 2, 3, 4 and 5 are prepared by respectively adding to the remaining four portions:

0.1 5 g of dioctylsulfosuccinate (Dispersion 2);

0.78 g of dioctylsulfosuccinate (Dispersion 3);

0.18 g of the sulfosuccinic acid mono-ester with cetylstearyl alcohol 30 moles propoxylated, 4 moles ethoxylated (Dispersion 4);

0.89 g of the sulfosuccinic acid mono-ester with cetylstearyl alcohol 30 moles propoxylated, 4 moles ethoxylated (Dispersion 5);

The five dispersions of the paper coating formulations are stirred for 15 minutes and mantained at 25° C.; Dispersion 1 too, even if it does not containing any additional ingredient, is stirred for 15 minutes before being tested, to guarante the comparability of the results.

The Brookfield viscosity of the Dispersion 1-5 is 1040 m*Pas (100 rpm).

Coating and Evaluation of Printability.

The paper coating is performed with the Dispersion 1-5 on industrial paper rotogravure sheets of 40 g/m².

A coating bar machine is used, suitable for the plane coating of A4 sheets; the machine has a set of bars wound by threads having different diameters, allowing to vary the volume of the coat by changing the dosing bar; it is also possible to vary the speed of the moving bar to modify the amount of coat applied.

The coating machine, after a series of tests made to optimize the procedure, is regulated to dose 8 g/m² of dry coat on the desired support. As the Dispersions 1-5 have the same contents of solids and the same rheology the regulation of the coating machine is the same in all tests and the machine constantly deposits 8 g/m² of dry coat.

Immediately after the coating, the sheets are dried with air for 15″ at 120° C., and then an maintained for 2 minutes at 110° C.

The coated sheets are allowed to stay in a conditioned room for 24 hours at 21° C. and 50% of relative humidity; then they are calendered with the temperature of the rolls set at 50° C., linear pressure=67.5 Kg/cm, 4 nip, and contacting the coated side of the sheets on the steel roll. After being calendered the sheets are again conditioned at 21° C. and 50% of relative humidity.

The rotogravure printability is evaluated with Heliotest, a universally known method which is used both in the paper industry for quality control and in the research laboratories to evaluate the quality of paper for rotogravure printing.

The printing pressure is set at 55 Kg for all tests; to minimise errors nine Heliotest values are taken from as many samples, cut from the five sheets coated with the Dispersions 1-5 (1-5 in Table 1); the value reported in Table 1 (Missing Dots—mm) is the average of the nine Heliotest values.

TABLE 1

| | 1* | 2 | 3 | 4 | 5 |
|---|---|---|---|---|---|
| Heliotest 20° | 63.0 | 73.2 | 69.5 | 69.0 | 76.1 |

*(comparative)

### EXAMPLE 2

Five aqueous dispersions of paper coating formulations are prepared with the following ingredients:
delaminated pre-dispersed kaolin for rotogravure printing, particle size 62% finer than 2 μm (Kaolin C);
delaminated kaolin, particle size 68% finer than 2 μm (Kaolin D);
Reotan A, dispersant based on sodium polyacrylate commercialised by Lamberti SpA (Italy);
78% by weight dispersion of calcium carbonate GCC, particle size about 90% finer than 2 μm (Carbonate A);
Acronal 500 D, an acrylic polymeric binder for rotogravure printing commercialised by BASF;

Preparation of the “Base” Aqueous Dispersion.

(The “base” aqueous dispersion will then be used to obtain the five aqueous dispersion of the paper coating formulations to be tested, to avoid experimental errors and to guarantee the comparability of the results)

A 68% by weight dispersion is prepared adding to 225.9 g of water, under vigorous stirring, 480 g of Kaolin C, 0.12 g of Reotan A and 25% aq. NaOH to obtain a pH of 8.5-9. The dispersion is obtained stirring with a caowles at 1000 rpm for 30 minutes.

Then, in the same manner a second dispersion (having a content of solids of 63% by weight) is prepared with: 480 g of Kaolin, 1.2 g of Reotan A and 25% aq. NaOH.

Then, in the same manner a third dispersion (having a content of solids of 60% by weight) is prepared with: 180 g of talc, 0.36 g of Reotan A and 25% aq. NaOH.

With the thus obtained three dispersions the “base” aqueous dispersion is prepared as follows.

The three dispersions are mixed with a caowles at 1000 rpm; then 76.9 g of Carbonate A are added and the mixture is homogenised by stirring at 1000 rpm for 30 minutes.

Then the stirring speed Is diminished to 700 rpm and 108 g of Acronal 500 D are added; after 10 minutes stirring 18 g of Lamkote are added; finally, 6 g of Viscolam 30 are added, always under stirring. The pH of the dispersion is then 8.5.

The dry fraction is then determined with a Mettler-Toledo thermo-balance set at 105° C. (result emitted after 3 minutes of constant weight) and water is added to dispersion until the desired value of dry fraction (52.7%) is obtained.

Finally the “base” aqueous dispersion is homogenised by stirring at 700 rpm for 1 5 minutes.

Four portions (each weighing 400 g) of the “base” aqueous dispersion are taken to prepare the aqueous dispersions of the paper coating formulations used for the following comparative tests.

The first portion is used as such as the aqueous dispersion of the reference paper coating formulation (Dispersion 6).

The Dispersion 7, 8 and 9 are prepared by respectively adding to the remaining three portions:

0.14 g of dioctylsulfosuccinate (Dispersion 7);

0.16 g of the sulfosuccinic acid mono-ester with cetylstearyl alcohol 30 moles propoxylated, 4 moles ethoxylated (Dispersion 8);

0.80 g of the sulfosuccinic acid mono-ester with cetylstearyl alcohol 30 moles propoxylated, 4 moles ethoxylated (Dispersion 9);

The four dispersions of the paper coating formulations are stirred for 15 minutes and mantained at 25° C.; Dispersion 6 too, even if it does not containing any additional ingredient, is stirred for 15 minutes before being tested, to guarante the comparability of the results.

Coating and Evaluation of Printability.

The paper coating is performed with the Dispersion 6-9 on industrial paper rotogravure sheets of 40 g/m².

The same coating bar machine used for Example 1.

The coating machine, after a series of tests made to optimize the procedure, is regulated to dose 8 g/m² of dry coat on the desired support. The regulation of the coating machine is the same in all the following tests.

Immediately after the coating, the sheets are dried with air for 15″ at 120° C, and then are maintained for 2 minutes at 110° C.

The coated sheets are allowed to stay in a conditioned room for 24 hours at 21° C. and 50% of relative humidity; then they are calendered with the temperature of the rolls set at 50° C., linear pressure=67.5 Kg/cm, 4 nip, and contacting the coated side of the sheets on the steel roll.

After being calendered the sheets are again conditioned at 21° C. and 50% of relative humidity.

The rotogravure printability is evaluated with Heliotest.

The printing pressure is set at 55 Kg for all tests; to minimise errors eight Heliotest values are taken from as many samples, cut from the five sheets coated with the Dispersions 6-9 (6-9 in Table 2); the value reported in Table 2 (Missing Dots—mm) is the average of the eight Heliotest values.

TABLE 2

| | 6* | 7 | 8 | 4 |
|---|---|---|---|---|
| Heliotest 20° | 62 | 68 | 63 | 75 |

*(comparative)

1-16. (canceled)

17. A paper coating formulation useful for rotogravure printing processes comprising:
a. 100 parts by weight of finely divided pigments;
b. from 0.001 to 5 parts by weight of a substance selected from the group consisting of: mono-alkylsulfosuccinate; di-alkylsulfosuccinates; sulfosuccinic acid mono-esters of ethoxylated and/or propoxylated fatty alcohols; sulfosuccinic acid di-esters of ethoxylated and propoxylated fatty alcohols; and mixtures thereof;
c. from 3 to 15 parts by weight of a polymeric acrylic binder; and
d. from 0.005 to 0.4 parts by weight of a dispersant.

18. The paper coating formulation according to claim 17 additionally comprising from 0.3 to 2 parts by weight of calcium stearate.

19. The paper coating formulation according to claim 17 wherein the sulfosuccinic acid mono- and di-esters of ethoxylated and/or propoxylated fatty alcohols are ethoxylated and/or propoxylated with from 1 to 50 moles of oxide.

20. The paper coating formulation according to claim 19 wherein the sulfosuccinic acid mono- and di-esters of ethoxylated and/or propoxylated fatty alcohols are ethoxylated and/or propoxylated with from 20 to 40 moles of oxide.

21. The paper coating formulation according to claim 17 wherein the mono-alkylsulfosuccinate and di-alkylsulfosuccinate are mono- or di-C₂-C₁₆ linear or branched alkylsulfosuccinates.

22. The paper coating formulation according to claim 17 wherein the di-alkylsulfosuccinate is dioctylsulfosuccinate.

23. The paper coating formulation according to claim 17 wherein the substance selected from the group consisting of: mono-alkylsulfosuccinate; di-alkylsulfosuccinates; sulfosuccinic acid mono-esters of ethoxylated and/or propoxylated fatty alcohols; sulfosuccinic acid di-esters of ethoxylated and/or propoxylated fatty alcohols; and mixtures thereof; is present at from 0.01 to 1 parts by weight.

24. The paper coating formulation according to claim 17 wherein the substance selected from the group consisting of: mono-alkylsulfosuccinate; di-alkylsulfosuccinates; sulfosuccinic acid mono-esters of ethoxylated and/or propoxylated fatty alcohols; sulfosuccinic acid di-esters of ethoxylated and/or propoxylated fatty alcohols; and mixtures thereof; is present at from 0.02 to 0.8 parts by weight.

25. The paper coating formulations according to claim 17 wherein the finely divided pigments have from 40 to 90% of the particles finer than 2 μm.

26. The paper coating formulation according to claim 25 wherein the mixture of finely divided pigments contains at least 30% by weight of kaolin for rotogravure printing having from 40 to 70% of the particles finer than 2 μm.

27. An aqueous dispersion useful for the coating of rotogravure printing paper comprising from 40 to 70% by weight of the paper coating formulation according to claim 1 and from 30 to 60% by weight of water.

28. The aqueous dispersion of claim 27 additionally comprising from 0.3 to 2 parts by weight of calcium stearate based upon the weight of the paper coating formulation according to claim 17.

29. A paper useful for rotogravure printing processes characterized by the fact that it is coated with from 4 to 15 g/m² of a thin layer of the paper coating formulation of claim 17.

30. The paper according to claim 29, characterized by the fact that it is coated with from 6 to 10 g/m² of a thin layer of the paper coating formulation of claim 17.

31. A method to improve the printability of rotogravure paper comprising the step of treating the paper with a paper coating formulations containing:
a. 100 parts by weight of finely divided pigments;
b. from 0.001 to 5 parts by weight of a substance selected from the group consisting of: mono-alkylsulfosuccinate; di-alkylsulfosuccinates; sulfosuccinic acid mono-esters of ethoxylated and/or propoxylated fatty alcohols; sulfosuccinic acid di-esters of ethoxylated and propoxylated fatty alcohols; and mixtures thereof;
c. from 3 to 15 parts by weight of a polymeric acrylic binder; and
d. from 0.005 to 0.4 parts by weight of a dispersant.

32. The method to according to claim 31, wherein the paper is coated with from 4 to 15 g/m² of the paper coating formulation.

33. The method according to claim 31, the paper coating formulation additionally comprising from 0.3 to 2 parts by weight of calcium stearate.

34. A method to improve the printability of rotogravure paper comprising the step of treating the paper with an aqueous dispersion consisting of from 30 to 60% by weight of water and from 40 to 70% by weight of a paper coating formulation containing:
a. 100 parts by weight of finely divided pigments;
b. from 0.001 to 5 parts by weight of a substance selected from the group consisting of: mono-alkylsulfosuccinate; di-alkylsulfosuccinates; sulfosuccinic acid mono-esters of ethoxylated and/or propoxylated fatty alcohols; sulfosuccinic acid di-esters of ethoxylated and propoxylated fatty alcohols; and mixtures thereof;
c. from 3 to 15 parts by weight of a polymeric acrylic binder; and
d. from 0.005 to 0.4 parts by weight of a dispersant.

35. The method according to claim 34, the paper coating formulation additionally comprising from 0.3 to 2 parts by weight of calcium stearate.

36. A paper coating formulation useful for rotogravure printing processes comprising:
a. 100 parts by weight of finely divided pigments;
b. from 0.001 to 5 parts by weight of a substance selected from the group consisting of: mono-alkylsulfosuccinate; di-alkylsulfosuccinates; sulfosuccinic acid mono-esters of ethoxylated and/or propoxylated fatty alcohols; sulfosuccinic acid di-esters of ethoxylated and propoxylated fatty alcohols; and mixtures thereof;
c. from 3 to 15 parts by weight of a polymeric acrylic binder;
d. from 0.005 to 0.4 parts by weight of a dispersant; and
e. from 0.3 to 2 parts by weight of calcium stearate.
